(19) United States
(12) Patent Application Publication
(10) Pub. No.: US 2009/0178886 A1
(43) Pub. Date: Jul. 16, 2009

(54) Ladder stabilizer

(76) Inventor: Robert Dale Joyner, Norman, OK (US)

Correspondence Address: James T. Robinson;Exclusivity-Law, Inc., 222 East Main Street, Norman, OK, 73069-1303, US

(21) Appl. No.: 12/008,419

(22) Filed: Jan. 11, 2008

(51) Int. Cl. E06C 7/06

(52) U.S. Cl. 182/206

(57) ABSTRACT

A ladder stabilizer for reducing slippage by the bottom portion of a straight or extension ladder placed on a ladder surface has a left hook portion for engaging the left rail of the ladder, a right hook portion for engaging the right rail of the ladder, and a bent nose portion connecting the left hook portion and the right hook portion. The left hook portion and the right hook portion are spread for installation on the left and right ladder rails, respectively, with the bent nose portion extending downwardly between the ladder rails from the left hook portion and the right hook portion, then return to the spring-biased normal position following installation. With the ladder stabilizer positioned with the bent nose portion touching the ladder surface, a force applied against the bent nose portion downwardly and toward the ladder frictionally biases the left hook portion in place around the left ladder rail, frictionally biases the right hook portion in place around the right ladder rail, and frictionally biases the bent nose portion of the ladder stabilizer against the ladder surface, thereby resisting slippage of the ladder on the ladder surface.

### BACKGROUND OF THE INVENTION

1. Field of the Invention

This invention relates to a stabilizer for ladders, and, more particularly, but not by way of limitation, to a stabilizer which attaches to the bottom portion (sometimes referred to herein, interchangeably, as the foot) of a straight ladder or an extension ladder and prevents the bottom portion of the ladder from sliding.

2. Discussion

According to a 2004 report published by The Center to Protect Workers' Rights, each year about 50 construction workers are killed by falls from ladders. More than half the deaths are for people working from ladders. The main cause of falls from straight and extension ladders is sliding of the ladder base. A 1993 publication by the University of Missouri Extension notes that, each year in the United States, accidents involving ladders cause an estimated 300 deaths and 130,000 injuries requiring emergency medical attention. The U.S. Consumer Product Safety Commission reported that each year there are more than 164,000 emergency-room treated injuries in the United States related to ladders. While the reported numbers of deaths and injuries vary, there is no doubt that ladder incidents account for the deaths of hundreds of workers and injuries to well over 100,000 each year in the United States.

Straight and extension metal ladders are normally fitted with a double edge steel prong foot to prevent slippage when the ladder is in use. The prong foot has double edges so the ladder may be used with either side up. It is recommended that a rubber safety shoe also be used if the ladder is to be positioned on a hard surface such as concrete. Steel prong feet simply do not hold well on hard surfaces. It is often recommended that an extra person be used to hold the bottom of the ladder (sometimes called “footing the ladder”) to insure the bottom of the ladder does not slip.

If a worker gets in trouble on a ladder, chances are very good the worker will get hurt. The recommended extra person to foot the ladder is quite often not available, and so worker on the ladder continues to be exposed to the possibility of injury due to slippage of the foot of the ladder.

Instructions for proper use of straight and extension ladders invariably state that the ground beneath the ladder should be both level and firm. Large flat wooden boards placed under the ladder can level a ladder on uneven ground or give a ladder better footing on soft ground. Sometimes the ladder's foot can be secured by a rope to prevent slippage.

Yet workers continue to be injured or killed in accidents involving ladders. Sometimes the location of the project dictates the topography of the ground or other surface. Sometimes a worker elects to go ahead with a project requiring immediate attention rather than wait for the arrival of an extra person or look for appropriate boards to improve the ladder's footing.

Accordingly, what is needed is a simple, economical stabilizer for attachment to the bottom portion of straight ladders and extension ladders, thereby reducing the tendency of the foot of the ladder to slip and, as a result, reducing the numbers of injuries and deaths experienced by workers on ladders.

### SUMMARY OF THE INVENTION

A ladder stabilizer for reducing slippage by the bottom portion of a ladder has a left hook portion for engaging the left rail of the ladder, a right hook portion for engaging the right rail of the ladder, and a bent nose portion connecting the left hook portion and the right hook portion, so that the left hook portion and the right hook portion are deformable for installation on the ladder rails yet return to their normal position after deformation. The left hook portion and the right hook portion are spread for installation on the left and right ladder rails, respectively, with the bent nose portion extending downwardly from the left hook portion and the right hook portion between the ladder rails. With the ladder stabilizer positioned on the ladder rails with the bent nose portion touching the ladder surface, a force applied against the bent nose portion downwardly and toward the ladder frictionally biases the left hook portion in place around the left ladder rail, frictionally biases the right hook portion in place around the right ladder rail, and frictionally biases the bent nose portion of the ladder stabilizer against the ladder surface so the ladder foot resists slippage on the ladder surface.

An object of the present invention is to provide a ladder stabilizer which causes the ladder foot to resist slippage on the ladder surface.

Yet another object of the present invention is to provide a ladder stabilizer which can be easily installed on the ladder by a single worker in the field.

Yet another object of the present invention is to provide a ladder stabilizer which does not interfere with normal extension ladder operation and can be left on the extension ladder at all times.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a view of a ladder stabilizer according to the present invention installed on a ladder.

FIG. 2 is a pictorial view of the ladder stabilizer shown in FIG. 1.

FIG. 3 is a side view of the ladder stabilizer shown in FIGS. 1-2.

FIG. 4 is a front view of the ladder stabilizer shown in FIGS. 1-3.

FIG. 5 is a top view of the ladder stabilizer shown in FIGS. 1-4.

FIG. 6 is a view showing the first step taken by a worker to install the ladder stabilizer shown in FIGS. 1-4 on the bottom portion of a ladder.

FIG. 7 is a view showing the second step taken by a worker to install the ladder stabilizer shown in FIGS. 1-4 on the bottom portion of a ladder.

FIG. 8 is a view showing the third step taken by a worker to install the ladder stabilizer shown in FIGS. 1-4 on the bottom portion of a ladder.

FIG. 9 is a view showing the fourth step taken by a worker to install the ladder stabilizer shown in FIGS. 1-4 on the bottom portion of a ladder.

FIG. 10 is a view of the ladder stabilizer shown in FIGS. 1-9 with an additional anchor attached thereto.

FIG. 11 a view of the ladder stabilizer with the additional anchor shown in FIG. 10 installed on the bottom portion of a ladder.

### DETAILED DESCRIPTION OF THE INVENTION

In the following description of the invention, like numerals and characters designate like elements throughout the figures of the drawings.

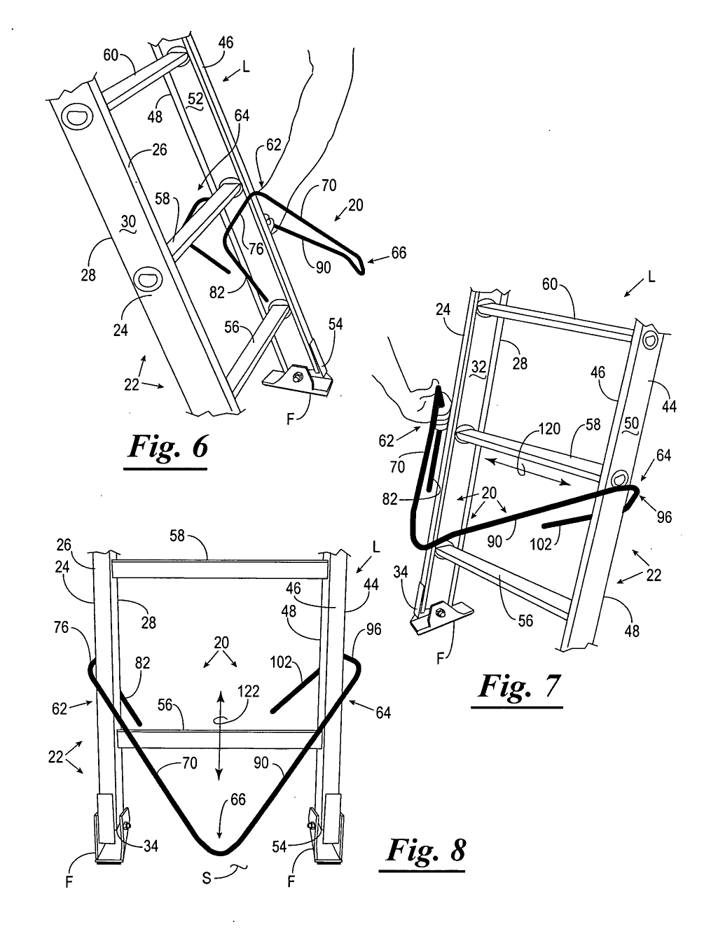

Referring now to FIG. 1 in conjunction with FIGS. 6-9, a ladder stabilizer 20 is attached to the bottom portion 22 of a ladder L having feet F resting on a surface S. A left rail 24 has a front 26, a rear 28, an outside 30, and an inside 32. The left rail 24 terminates at a lower end 34 to which one of the feet F is attached. A right rail 44 has a front 46, a rear 48, an outside 50, and an inside 52. The right rail 44 terminates at a lower end 54 to which the other foot F is attached.

Still referring to FIG. 1 in conjunction with FIGS. 6-9, the lower portion 22 of ladder L has, in ascending order, a first rung 56, a second rung 58, and a third rung 60 disposed between and supported by the left rail 24 and the right rail 44.

Still referring to FIG. 1 in conjunction with FIGS. 6-9, the ladder stabilizer 20 has a left hook portion 62 and a right hook portion 64 connected by a bent nose portion 66.

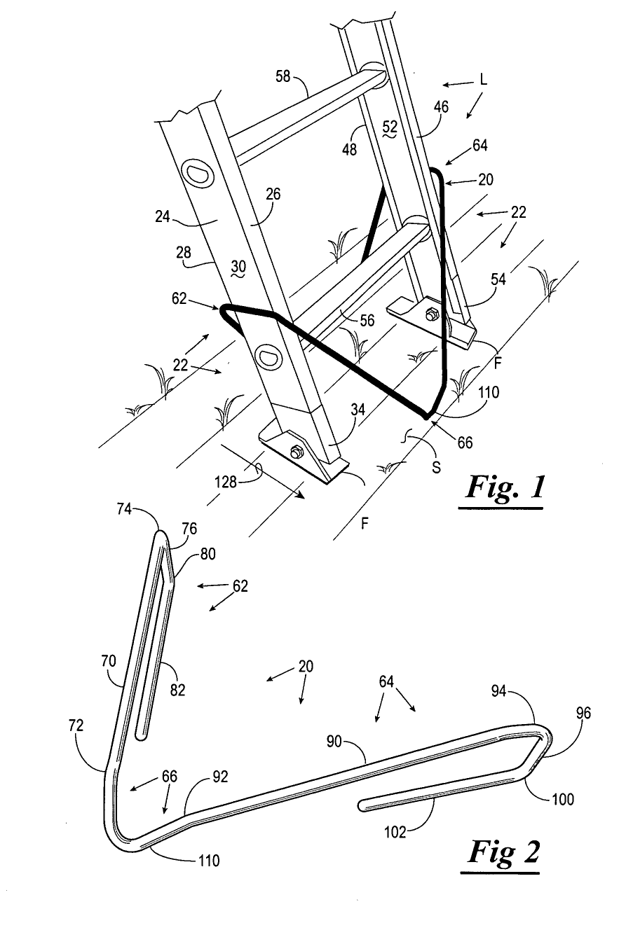

Referring now to FIGS. 2-5, the left hook portion 62, the right hook portion 64, and the bent nose portion 66 will be described in greater detail. A left runner 70 is connected to the bent nose portion 66 at one end 72 and at the other end 74 to one end of a left rail-spanning member 76 at an angle 78 of about 75-85 degrees. The other end 80 of the left rail-spanning member 76 is connected to one end of a left retaining member 82. The left retaining member 82 angles downwardly behind the left ladder rail 24, as more clearly shown in FIG. 8. When the ladder stabilizer 20 is installed on the ladder L, the left runner 70 crosses the front 26 of the left rail 24, the left rail-spanning member 76 lies adjacent the outside 30 (See FIG. 1) of the left rail 24, and the left retaining member 82 extends downwardly and toward the bent nose portion 66 of the stabilizer 20 (See FIG. 8) behind the left rail 24.

Referring still to FIGS. 2-5, a right runner 90 is connected to the bent nose portion 66 at one end 92 and at the other end 94 to one end of a right rail-spanning member 96 at an angle 98 of about 75-85 degrees. The other end 100 of the right rail-spanning member 96 is attached to one end of a right retaining member 102. The right retaining member 102 angles downwardly behind the right ladder rail 44, as more clearly shown in FIG. 8. When the ladder stabilizer 20 is installed on the ladder L, the right runner 90 crosses the front 46 of the left rail 44, the right rail-spanning member 96 lies adjacent the outside 50 (See FIG. 1) of the right rail 44, and the right retaining member 102 extends downwardly and toward the bent nose portion 66 of the stabilizer 20 (See FIG. 8) behind the right rail 44.

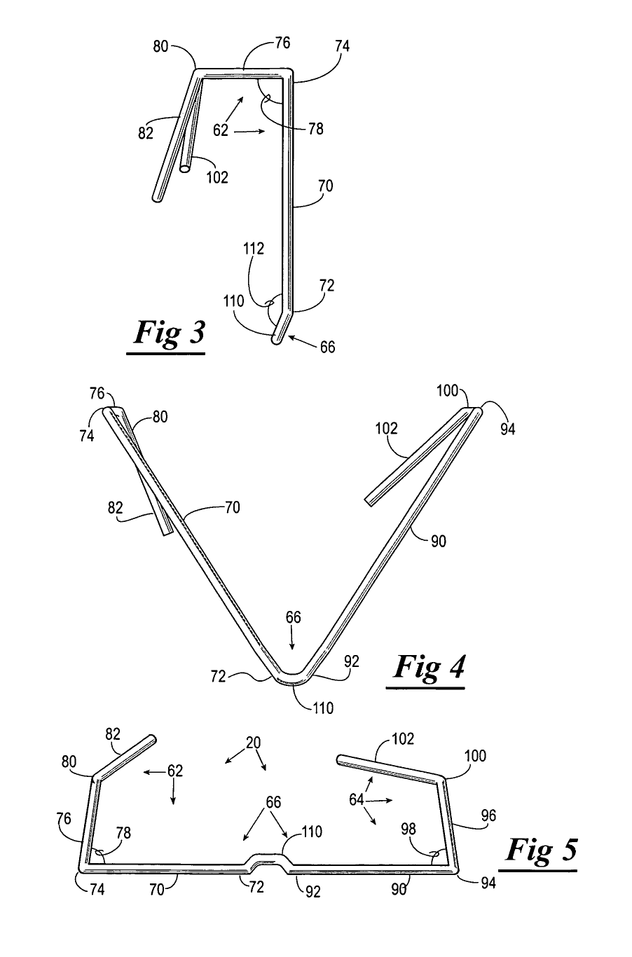

Referring still to FIGS. 2-5, the bent nose portion 66 of the stabilizer 20 is formed by a substantially vee-shaped member 110 connected on one end to the end 72 of the left runner 70 and at the other end to the end 92 of the right runner 90. The vee-shaped member 110 forms an angle 112 of about 130-150 degrees with respect to the runners 70, 90 (See FIG. 3).

It will be understood by one skilled in the art that the ladder stabilizer 20 is made from a single piece of metal which has the capacity return to its original shape despite significant twisting or bending. See FIG. 7. Rebar (short for “reinforcing bar”), a common steel bar used for reinforcing concrete (usually formed from carbon steel) has been found to be a good choice for the ladder stabilizer 20. The ridges present on rebar are though to provide improved frictional contact with the ladder rails 24, 44. Spring steel, a low allow, medium carbon steel with a very high yield strength, is also suitable for construction of the ladder stabilizer 20 according to the present invention.

Referring now to FIGS. 6-9, the installation of the ladder stabilizer 20 on the ladder L is illustrated. The worker first grasps the right runner 90 as shown in FIG. 6 and attaches the right hook portion 64 to the right rail 44. The worker then grasps the left runner 70 and exerts a force in the direction of arrow 120, as shown in FIG. 7, thereby spreading the left hook portion 62 and the right hook portion 64 to permit placement of the left retaining member 72 (See FIGS. 2-5) behind the left rail 24. The worker then releases the force previously applied in the direction of arrow 120, and the left hook portion 62 moves back toward the right hook portion 64 so the ladder stabilizer 20 is attached to the ladder L as shown in FIG. 8.

Referring now to FIG. 8, the left hook portion 62 and the right hook portion 64 cooperate to deploy the ladder stabilizer 20 as shown. The ladder stabilizer 20 is slidably attached to the left rail 24 and the right rail 44 of the ladder L so the stabilizer 20 is free to move up and down along arrow 122.

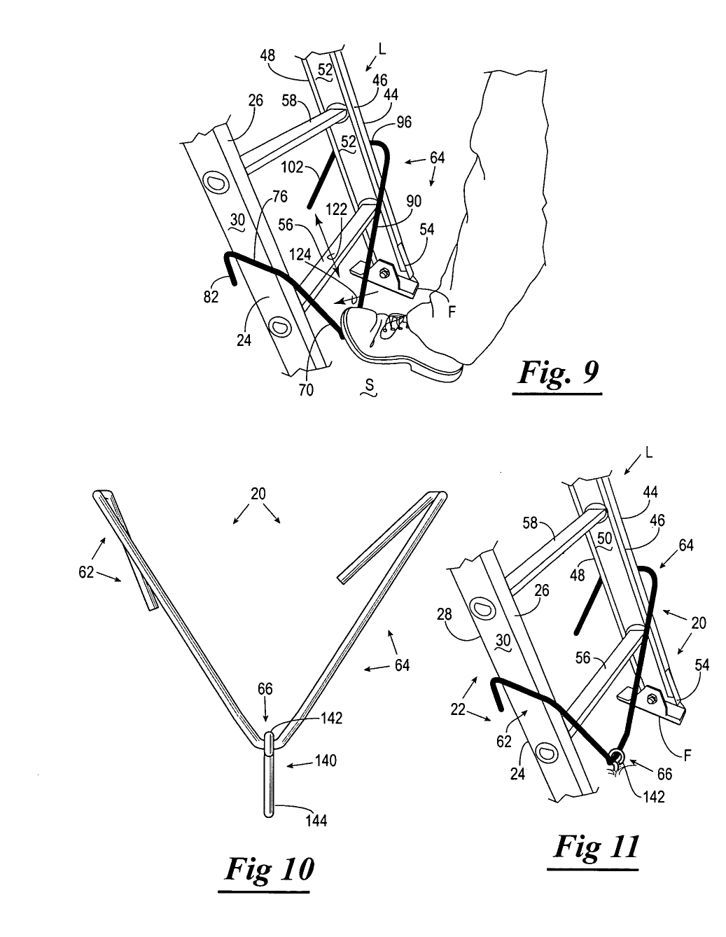

Referring now to FIG. 9, the worker positions the stabilizer 20 so the vee-shaped member 110 of the bent nose portion 66 is touching the surface S. The worker then places a foot on the bent nose portion 66 and applies a force downward and toward the back of the ladder L along arrow 124. The result is shown in FIG. 1.

Referring once again to FIG. 1, the ladder stabilizer 20 is installed on the ladder L. The vee-shaped member 110 is frictionally biased against the surface S so as to resist slippage of the bottom portion 22 of the ladder L along arrow 128.

It will be understood by one skilled in the art that the vee-shaped member 110 of the bent nose portion 66 of the ladder stabilizer 20 acts as a cleat to engage the surface S. The worker's forcing of the vee-shaped member 110 in the direction of the arrow 124 simultaneously creates a frictional bias of the left hook portion 62 around the left rail 24 and of the right hook portion 64 around the right rail 44, thereby preventing the ladder stabilizer 20 from sliding oh the rails 24, 44.

It will be further understood by one skilled in the art that the worker's forcing of the vee-shaped member 110 in the direction of the arrow 124 creates a clamping force whereby the left hook portion 62 is clamped to the left rail 24 and the right hook portion 64 is clamped to the right rail 44.

Referring now to FIGS. 9-11, shown therein is the ladder stabilizer 20 with an additional anchor 140 for use when the surface S on which the ladder L rests is a penetrable surface. The additional anchor 140 has an eye 142 attached to a spike 144. The eye 142 is sized to slide over a retaining member (82, 102), across a rail-spanning member (76, 96), and down a runner (70, 90) to a position in the vee-shaped member 110 as shown in FIG. 10. When the worker forces the vee-shaped member 110 against the surface S, the spike 144 of the additional anchor 140 is caused to penetrate the surface S to create an additional resistance against slippage along the arrow 128 (See FIG. 1).

It will be understood by one skilled in the art that the ladder stabilizer 20, either alone or with the additional anchor 140, does not interfere with normal operation of either straight ladders or extension ladders. Thus the ladder stabilizer 20 can be installed on straight ladders and extension ladders and left in place, thereby facilitating increased safety for ladder workers.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A ladder stabilizer for reducing slippage by the bottom portion of a straight or extension ladder placed on a ladder surface, the ladder having a left rail and a right rail connected by ladder rungs, the ladder stabilizer comprising:
a left hook portion for engaging the left rail of the ladder;
a right hook portion for engaging the right rail of the ladder; and
a bent nose portion connecting the left hook portion and the right hook portion, so that the left hook portion and the right hook portion are deformably spring-biased in a normal position;
wherein the left hook portion and the right hook portion are spread for installation on the left and right ladder rails, respectively, with the bent nose portion extending downwardly from the left hook portion and the right hook portion between the ladder rails, wherein the left hook portion and the right hook portion return to the spring-biased normal position following installation; and
wherein, with the ladder stabilizer positioned with the bent nose portion touching the ladder surface, a force applied against the bent nose portion downwardly and toward the ladder frictionally biases the left hook portion in place around the left ladder rail, frictionally biases the right hook portion in place around the right ladder rail, and frictionally biases the bent nose portion of the ladder stabilizer against the ladder surface, thereby resisting slippage of the ladder on the ladder surface.

2. The ladder stabilizer of claim 1, wherein the left hook portion further comprises:
a left runner connected to the bent nose portion at one end and at the other end to one end of a left rail-spanning member;
a left retaining member attached to the other end of the left rail-spanning member; and
wherein, when the ladder stabilizer is installed on the ladder, the left retaining member angles downwardly behind the left ladder rail, the left runner crosses the front of the left rail, the left rail-spanning member lies adjacent the outside of the left rail, and the left retaining member extends downwardly and toward the bent nose portion of the stabilizer behind the left rail.

3. The ladder stabilizer of claim 2, wherein the right hook portion further comprises:
a right runner connected to the bent nose portion at one end and at the other end to one end of a right rail-spanning member;
a right retaining member attached to the other end of the right rail-spanning member; and
wherein, when the ladder stabilizer is installed on the ladder, the right retaining member angles downwardly behind the right ladder rail, the right runner crosses the front of the right rail, the right rail-spanning member lies adjacent the outside of the right rail, and the right retaining member extends downwardly and toward the bent nose portion of the stabilizer behind the right rail.

4. The ladder stabilizer of claim 3, wherein the bent nose portion further comprises:
a substantially vee-shaped member connected on one end to the end of the left runner and at the other end to the end of the right runner.

5. The ladder stabilizer of claim 2, wherein the left runner is connected to left rail-spanning member at an angle of 75-85 degrees.

6. The ladder stabilizer of claim 4, wherein the right runner is connected to the right rail-spanning member at an angle of 75-85 degrees.

7. The ladder stabilizer of claim 4, wherein the vee-shaped member forms an angle of about 130-150 degrees with respect to the runners.

8. The ladder stabilizer of claim 1, wherein the ladder stabilizer is formed from rebar.

9. The ladder stabilizer of claim 1, wherein the ladder stabilizer is formed from spring steel.

10. The ladder stabilizer of claim 4, further comprising an additional anchor attached to the bent nose portion, wherein the additional anchor penetrates the ladder surface and provides additional resistance to slippage by the ladder on the ladder surface.

11. The ladder of stabilizer of claim 10, wherein the additional anchor further comprises an eye attached to a spike, so the eye slides over a retaining member, across a rail-spanning member, and down a runner to a position in the vee-shaped member and the spike rests against the ladder surface, so application of force to the vee-shaped member to force the vee-shaped member against the ladder surface causes the spike to penetrate the surface to create an additional resistance against slippage of the ladder on the ladder surface.

12. The ladder stabilizer of claim 4, wherein the ladder stabilizer is formed from rebar.

13. The ladder stabilizer of claim 4, wherein the ladder stabilizer is formed from spring steel.

14. The ladder stabilizer of claim 6, wherein the vee-shaped member forms an angle of about 130-150 degrees with respect to the runners.

15. The ladder stabilizer of claim 14, wherein the ladder stabilizer is formed from rebar.

16. The ladder stabilizer of claim 14, wherein the ladder stabilizer is formed from spring steel.
